(19) United States
(12) Patent Application Publication
(10) Pub. No.: US 2022/0180093 A1
(43) Pub. Date: Jun. 9, 2022

(54) FORM INFORMATION EXTRACTING METHOD, APPARATUS, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Kai ZENG, Beijing (CN); Sijin WU, Beijing (CN); Hua LU, Beijing (CN); Yiyu PENG, Beijing (CN); Yongfeng CHEN, Beijing (CN)

(73) Assignee: BEIJING BAIDU NETCOM SCIENCE AND TECHNOLOGY CO., LTD., Beijing (CN)

(21) Appl. No.: 17/382,610

(22) Filed: Jul. 22, 2021

(30) Foreign Application Priority Data
Dec. 8, 2020 (CN) 202011443512.7

(51) Int. Cl. G06K 9/00; G06F 40/30; G06F 40/295

(52) U.S. Cl. CPC G06K 9/00463; G06K 9/00469; G06K 2209/01; G06F 40/295; G06F 40/30

(57) ABSTRACT

The present disclosure provides a form information extracting method, apparatus, electronic device and storage medium and relates to the field of artificial intelligence such as natural language processing, computer vision and deep learning. The method includes: for a form to be processed, obtaining feature information of characters in the form, respectively; determining types of the characters respectively and determining a reading order of the characters according to the feature information; extracting a predetermined type of information content from the form according to the types and the reading order of the characters. The solution of the present disclosure may be applied to save the manpower and time costs, and improve the information-extracting efficiency and the accuracy of extraction results.

### CROSS-REFERENCE TO RELATED APPLICATIONS

The present application claims the priority of Chinese Patent Application No. 202011443512.7, filed on Dec. 8, 2020, with the title of “Form information extracting method, apparatus, electronic device and storage media.” The disclosure of the above application is incorporated herein by reference in its entirety.

### TECHNICAL FIELD

The present disclosure relates to the field of artificial intelligence, and particularly to a form information extracting method, apparatus, electronic device and storage medium in the field of natural language processing, computer vision and deep learning.

### BACKGROUND

In the real world, a lot of information exists in paper-based forms and might be of great significance for users.

Correspondingly, information extraction needs to be performed from the forms. A conventional form information extracting manner is a manual extraction manner, which consumes a lot of manpower and time costs and exhibits a poor efficiency.

### SUMMARY

The present disclosure provides a form information extracting method, apparatus, electronic device and storage medium.

A method for extracting form information includes for a form to be processed, obtaining feature information of characters in the form, respectively; determining types of the characters respectively and determining a reading order of the characters according to the feature information; extracting a predetermined type of information content from the form according to the types and the reading order of the characters.

An electronic device includes at least one processor; and a memory communicatively connected with the at least one processor; wherein the memory stores instructions executable by the at least one processor, and the instructions are executed by the at least one processor to enable the at least one processor to perform a method for extracting form information, wherein the method includes: for a form to be processed, obtaining feature information of characters in the form, respectively; determining types of the characters respectively and determining a reading order of the characters according to the feature information; extracting a predetermined type of information content from the form according to the types and the reading order of the characters.

A non-transitory computer readable storage medium with computer instructions stored thereon, wherein the computer instructions are used for causing a computer to perform a method for extracting form information, wherein the method includes: for a form to be processed, obtaining feature information of characters in the form, respectively; determining types of the characters respectively and determining a reading order of the characters according to the feature information; extracting a predetermined type of information content from the form according to the types and the reading order of the characters.

An embodiment of the present disclosure has the following advantages or advantageous effects: the desired information content may be automatically extracted from the form, so that the manpower and time costs may be saved, the information-extracting efficiency may be improved, and meanwhile, information extraction may be performed according to the feature information, the types and the reading order of the characters such that the accuracy of the extraction results may be ensured.

It will be appreciated that the Summary part does not intend to indicate essential or important features of embodiments of the present disclosure or to limit the scope of the present disclosure. Other features of the present disclosure will be made apparent by the following description.

### BRIEF DESCRIPTION OF THE DRAWINGS

The figures are only intended to facilitate understanding the solutions, not to limit the present disclosure. In the figures,

FIG. 1 illustrates a flow chart of a method for extracting form information according to an embodiment of the present disclosure;

FIG. 2 illustrates a schematic diagram of a manner of extracting, from a form, explicit key-value pair content and table content according to types of characters and a reading order according to the present disclosure;

FIG. 3 illustrates a schematic diagram of a form according to the present disclosure;

FIG. 4 illustrates a schematic diagram of an embodiment of an apparatus 40 for extracting form information according to the present disclosure;

FIG. 5 illustrates a block diagram of an electronic device for implementing the method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

In addition, the term “and/or” used in the text is only an association relationship depicting associated objects and represents that three relations might exist, for example, A and/or B may represents three cases, namely, A exists individually, both A and B coexist, and B exists individually. In addition, the symbol “I” in the text generally indicates associated objects before and after the symbol are in an “or” relationship.

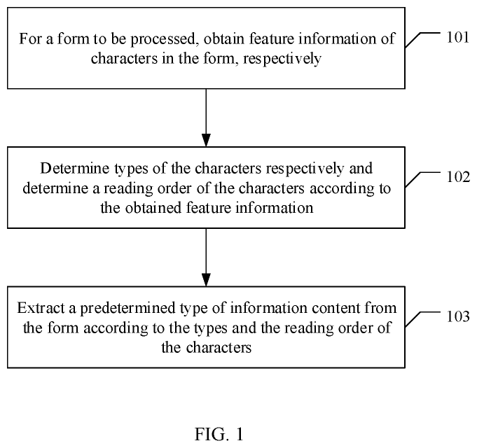

FIG. 1 illustrates a flow chart of a method for extracting form information according to an embodiment of the present disclosure. As shown in FIG. 1, the embodiment includes the following specific implementation mode:

In step 101, for a form to be processed, feature information of characters in the form is obtained respectively.

In step 102, according to the obtained feature information, types of the characters are determined respectively and a reading order of the characters is determined.

In step 103, according to the types and the reading order of the characters, a predetermined type of information content is extracted from the form.

It can be seen that in the solution described in the above method embodiment, the desired information content may be automatically extracted from the form, thereby saving manpower and time costs, and improving the efficiency of information extraction. At the same time, the information may be extracted in conjunction with the feature information of the characters, the types of the characters and the reading order, thereby ensuring the accuracy of an extraction result.

The form mentioned in the present disclosure usually refers to a paper-based form. Correspondingly, as for the form to be processed, it is further necessary to obtain an image corresponding to the form, such as a scanned copy of the form, and perform text detection on the image to obtain the detected characters. A conventional text detection technique may be used to perform text detection on the image.

The feature information of the characters may be obtained respectively. The obtained feature information may include: text semantic information of the character, and/or position information of the character, and/or image information of an image region where the character is located, and so on. That is, it is feasible to obtain any one of the text semantic information of the character, the position information of the character and the image information of the image region where the character as the feature information of the character, or obtain any two of the text semantic information of the character, the position information of the character and the image information of the image region where the character is located as the feature information of the character, or obtain the text semantic information of the character, the position information of the character and the image information of the image region where the character is located simultaneously as the feature information of the character. Preferably, the last manner may be employed to combine with the vision, position and text information simultaneously and thereby improve the accuracy of subsequent processing.

For each character, the semantic information and context information of the character may be encoded respectively, and a vector representation obtained from the encoding is regarded as the text semantic information of the character.

For example, a pre-trained language model may be used to encode the semantic information and context information of the character to obtain the vector representation after the encoding, as the text semantic information of the character. In other words, the vector representation contains both the semantic information and context information of the character.

For each character, coordinates of an upper left corner and a lower right corner of a rectangular box where the character is located may also be obtained, respectively, and the obtained coordinates may be converted into a vector representation as the position information of the character. The rectangular frame is a rectangular box of a predetermined size including the character.

In a conventional manner, when text detection is performed, a rectangular box is determined correspondingly for each character; coordinates of the upper left corner and lower right corner of the rectangular box may be obtained, namely, xy-coordinates, and may be converted into a vector representation as the position information of the character. How to convert the coordinates is not limited and may be determined according to actual needs.

For each character, a predetermined image feature may also be extracted from the image region where the character is located, as the image information of the image region where the character is located. The image region where the character is located is an image region corresponding to the rectangular box.

For example, a classic network for instance segmentation tasks, namely Mask-RCNN (Mask-Region-based Convolutional Network) may be used to extract predetermined image features from the image region where the character is located. Which image features are specifically included may be determined according to actual needs.

Through the above processing, the feature information of each character may be obtained quickly and accurately, thereby laying a good foundation for subsequent processing.

Further, the types of the characters may be determined respectively according to the obtained feature information, i.e., classification tasks of character granularities may be performed. There is no restriction on how to determine the type of the characters according to the feature information. For example, a pre-trained model may be used to predict the types of the characters by using the corresponding feature information for each character.

In addition, the reading order of the characters may also be determined, i.e., a reading order prediction task may be performed. For example, the next character of each character may be determined to thereby obtain the reading order of all characters.

As for a form, the form might contain complex layouts such as columns, floating pictures, tables, etc. It is very necessary to find a correct reading order of the characters. The content and semantics of the form can be correctly understood only according to the correct reading order, so that desired information content can be extracted accurately and completely.

Correspondingly, for each character in the form, the next character of each character may be determined, i.e., what the next character is may be determined, where if the next character of a certain character points to itself or is empty, it may be believed that the current semantic segment ends. There are also no restrictions on how to determine the next character of each character. For example, a pre-trained model may be used to predict the next character of each character based on the feature information of each character.

Each character may be defined as a unique character based on its semantic information and position information. For example, for the character “ [symbol] (I)” in the text information “ [symbol] (I live in the city of Beijing now)”, the next character is “ [symbol] ”; for the character “ [symbol] ”, the next character is “ [symbol] ”, and so on so forth. The two characters “ [symbol] ” in the text information are treated as two different characters.

Through the above processing, the reading order of the characters in the form may be obtained.

Then, a predetermined type of information content may be extracted from the form according to the types and the reading order of the characters.

The predetermined type of information content may include explicit key-value pair content and/or table content, that is, only the explicit key-value pair content may be extracted, or only the table content may be extracted, or both the explicit key-value pair content and table content may be extracted, respectively.

In addition, the types of the characters may include a primary type and a secondary type.

The primary type may include: a start of a key, a middle of the key, an end of the key, a start of a value, a middle of the value, an end of the value, a start of a cell, a middle of a cell, an end of a cell, and others.

The secondary type may include: whether it is a header (a header or not a header), etc. For example, for a certain character, the type thereof may be determined as: a middle of a cell, not a header.

Specific types included in the types of characters may be determined according to actual needs, and the above are only examples.

When the explicit key-value pair content is extracted from the form, the explicit key-value pair content may be extracted from the form in conjunction with the type of each character, and the type of next character of each character.

For example, the type of each character may be judged in turn; if the type of a certain character “ [symbol] ” is a start of a key, the next character thereof is the character “ [symbol] ” whose type is a middle of the key, the next character of the character “ [symbol] ” is character “ [symbol] ” whose type is the middle of the key, the next character of the character “ [symbol] ” is the character “ [symbol] ” whose type is an end of the key, and the key “ [symbol] .” may be obtained. Similarly, a value corresponding to the key may be obtained, and assumed to be “ [symbol] ”. Then, “ [symbol] ” is extracted explicit key-value pair content.

Table content may be divided into two categories, namely, ordinary cell content and header content. When the table content is extracted from the form, the cell content may be extracted from the form according to the type of each character and the type of the next character of the each character. For any cell content, if any character in the cell content is determined as a header, the cell content may be determined as the header content, and the header content and the cell content other than the header content are taken as the table content extracted from the form.

For example, the types of the characters may be determined in turn. If the type of a character a is the start of the cell, the type of the next character b is the middle of the cell, and the type of the next character c of the character b is the end of the cell, cell content consisting of character a, character b, and character c may be obtained.

In addition, if any cell content includes a character that is a header, the cell content may be determined as the header content, otherwise, the cell content is ordinary cell content.

For example, suppose that a total of 6 cell contents are extracted, namely, cell content 1 to cell content 6, wherein cell content 1 and cell content 2 each include a character that is a header, then the cell content 1 and cell content 2 may be determined as the header contents, and the two header contents, cell content 3, cell content 4, cell content 5, and cell content 6 are taken as the extracted table content.

Further, positions of the extracted header contents and cell contents in the table may also be determined respectively, and the header contents and cell contents are sequentially output according to the positions.

For example, a pre-trained model may be used to predict the content of the next cell in the same row and the content of the next cell in the same column for each header content and cell content respectively, and parse the rows and columns of the table based on this information, that is, respectively determine the row and column positions of each header content and cell content in the table, and then output the header content and cell content sequentially according to the row and column positions, so that the output table content is clearer and more accurate.

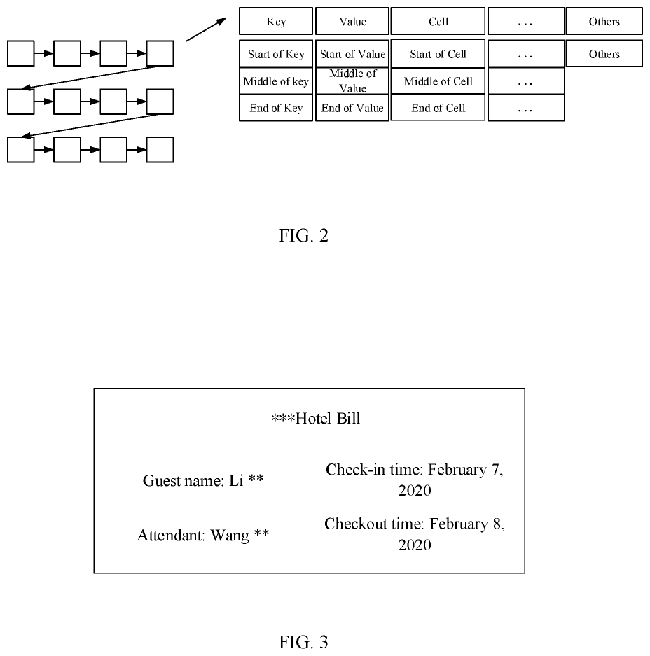

Based on the above introduction, FIG. 2 illustrates a schematic diagram of a manner of extracting, from a form, explicit key-value pair content and table content according to types of characters and a reading order according to the present disclosure. The left side in the figure represents the reading order. Reference may be made to the above depictions for a specific implementation, and no details will be presented any more here.

In addition to the explicit key-value pair content and table content that may be extracted from the form, the present disclosure also proposes that implicit key-value pair content may be extracted from the form.

If a question set by the user may be obtained, an answer corresponding to the question may be determined according to text information in the form (text information formed characters in the form), and the question and the corresponding answer may be taken as the implicit key-value pair content extracted from the form.

Some key-value pair content might not be explicitly present in the text information of the form. At this time, the desired content cannot be obtained in the explicit key-value pair content extraction manner. Therefore, the present disclosure further proposes a key-value pair content extraction manner based on a question-answer method.

For example, the question set by the user may be taken as a key, the pre-trained model may be used to predict a start position and an end position of the answer from the text information of the form, to obtain one or more answer intervals, and select the content in an answer interval with a maximum confidence as the desired answer, namely, a value corresponding to the key.

Through the above processing, the content of the key does not need to appear in the form explicitly, and the corresponding value may also be extracted, thereby enriching the extracted information content and so on.

FIG. 3 illustrates a schematic diagram of a form according to the present disclosure. The explicit key-value pair content and the implicit key-value pair content as shown in Table 1 (including but not limited to what are shown in Table 1) may be extracted from the text information in the form shown in FIG. 3.

TABLE 1
Explicit and implicit
key-value pair content

| | Key | Value |
|---|---|---|
| Explicit | Guest name | [symbol] ** (Li **) |
| Implicit | Hotel name | *** [symbol] (*** Hotel) |

In addition, for the unextracted text information in the form, the information content of the type other than the predetermined type may also be extracted from the unextracted text information in a named entity recognition manner, i.e., the key-value pair content and the information content of types other than the type such as table content may be extracted.

After the key-value pair content and the table content in the form are parsed and extracted, some elements that do not have an obvious structure and are not parsed might still exist in the form, for example, a printing time of the form and a name of a source organization of the form. Information such as the time and the organization name may be extracted therefrom by a fine-grained sequence labeling scheme and in a named entity recognition manner, as the information content of the corresponding type, for example, the extracted time may be taken as the printing time of the form, and the extracted organization name may be taken as the name of the source organization of the form, so that the extracted information content may be further enriched.

As appreciated, for ease of description, the aforesaid method embodiments are all described as a combination of a series of actions for purpose of brief depictions, but those skilled in the art should appreciated that the present disclosure is not limited to the described order of actions because some steps may be performed in other orders or simultaneously according to the present disclosure. Secondly, those skilled in the art should also appreciate the embodiments described in the description all belong to preferred embodiments, and the involved actions and modules are not necessarily requisite for the present disclosure.

In summary, with the solution described in the method embodiment of the present disclosure being employed, the manpower and time costs may be saved, the information-extracting efficiency may be improved, and meanwhile the accuracy and richness of the extraction results may be ensured. Furthermore, the solution has better generalization performance and robustness and may be adapted for demands for extraction of general-purpose information under different scenarios, and may conveniently and quickly extract information in forms of types such as supermarket shopping receipts, hotel bills, bank receipts, and has wide applicability.

The method embodiment is introduced above. The solution of the present disclosure will be further described hereunder through an apparatus embodiment.

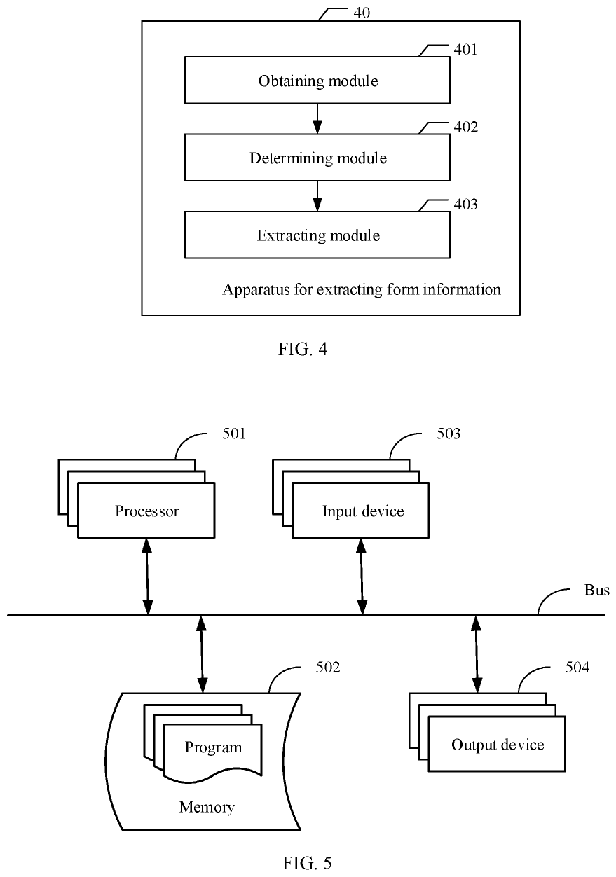

FIG. 4 illustrates a schematic diagram of an embodiment 40 of an apparatus for extracting form information according to the present disclosure. As shown in FIG. 4, the apparatus comprises: an obtaining module 401, a determining module 402 and an extracting module 403.

The obtaining module 401 is configured to, for a form to be processed, obtain feature information of characters in the form, respectively.

The determining module 402 is configured to determine types of the characters respectively and determine a reading order of the characters according to the feature information.

The extracting module 403 is configured to extract a predetermined type of information content from the form according to the types and the reading order of the characters.

The form mentioned in the present disclosure usually refers to a paper-based form. Correspondingly, as for the form to be processed, the obtaining module 401 further need to obtain an image corresponding to the form, such as a scanned copy of the form, and perform text detection on the image to obtain the detected characters.

As for each character, the obtaining module 401 may obtain feature information thereof. The obtained feature information may include: text semantic information of the character, and/or position information of the character, and/or image information of an image region where the character is located, and so on.

The obtaining module 401, for each character, encodes the semantic information and context information of the character, respectively, and regards a vector representation obtained from the encoding as the text semantic information of the character.

For example, a pre-trained language model may be used to encode the semantic information and context information of the character to obtain the vector representation after the encoding, as the text semantic information of the character.

The obtaining module 401 is further configured to, for each character, obtain coordinates of an upper left corner and a lower right corner of a rectangular box where the character is located, respectively, and convert the obtained coordinates into a vector representation as the position information of the character. The rectangular frame is a rectangular box of a predetermined size including the character.

The obtaining module 401 is further configured to, for each character, extract a predetermined image feature from the image region where the character is located, as the image information of the image region where the character is located. The image region where the character is located is an image region corresponding to the rectangular box.

For example, a classic network for instance segmentation tasks, namely Mask-RCNN, may be used to extract predetermined image features from the image region where the character is located.

Furthermore, the determining module 402 is configured to determine the types of the characters respectively according to the feature information. For example, a pre-trained model may be used to predict the types of the characters by using the corresponding feature information for each character.

In addition, the determining module 402 is further configured to determine the next character of each character respectively to obtain a reading order of the characters. For example, a pre-trained model may be used to predict the next character of each character according to the feature information of each character.

Then, the extracting module 403 may extract a predetermined type of information content from the form according to the types and the reading order of the characters.

The predetermined type of information content may include explicit key-value pair content and/or table content.

In addition, the types of the characters may include a primary type and a secondary type.

The primary type may include: a start of a key, a middle of the key, an end of the key, a start of a value, a middle of the value, an end of the value, a start of a cell, a middle of a cell, an end of a cell, and others.

The secondary type may include: whether it is a header (a header or not a header), etc. For example, for a certain character, the type thereof may be determined as: a middle of a cell, not a header.

When extracting the explicit key-value pair content from the form, the extracting module 403 may extract the explicit key-value pair content from the form in conjunction with the type of each character, and the type of next character of the each character.

Table content may be divided into two categories, namely, ordinary cell content and header content. When extracting the table content from the form, the extracting module 403 extracts the cell content from the form according to the type of each character and the type of the next character of the each character, and for any cell content, if determining any character in the cell content as a header, determines the cell content as the header content, and takes the header content and the cell content other than the header content as the table content extracted from the form.

Furthermore, the extracting module 403 is further configured to respectively determine positions of the extracted header content and cell content in the table, and then output the header content and cell content sequentially according to the positions.

In addition to the explicit key-value pair content and table content that may be extracted from the form, the present disclosure further proposes that implicit key-value pair content may be extracted from the form.

Correspondingly, the extracting module 403 may obtain a question set by the user, determine an answer corresponding to the question according to text information in the form, and take the question and the corresponding answer as the implicit key-value pair content extracted from the form.

In addition, for the unextracted text information in the form, the extracting module 403 may further extract information content of the type other than the predetermined type from the unextracted text information in a named entity recognition manner, i.e., extract the key-value pair content and the information content of types other than the type such as table content.

Reference may be made to corresponding depictions in the aforesaid method embodiment for a specific workflow of the apparatus embodiment shown in FIG. 4. The workflow is not detailed any more.

To sum up, with the solution described in the apparatus embodiment of the present disclosure being employed, the manpower and time costs may be saved, the information-extracting efficiency may be improved, and meanwhile the accuracy and richness of the extraction results may be ensured. Furthermore, the solution has better generalization performance and robustness.

The solution of the present disclosure may be applied to field of artificial intelligence, and particularly to the field of natural language processing, computer vision and deep learning.

Artificial intelligence is a branch of science concerned with using a computer to simulate a human being's some thinking processes and intelligent behaviors (e.g., learning, reasoning, thinking, planning etc.) and integrates techniques at the hardware level and techniques at the software level. Artificial intelligence hardware techniques generally include sensors, dedicated artificial intelligence chips, cloud computing, distributed storage, big data processing etc. Artificial intelligence software techniques mainly include major aspects such as compute vision technique, speech recognition technique, natural language processing technique, machine learning/deep learning, big data processing technique, and knowledge graph technique.

According to embodiments of the present disclosure, the present disclosure further provides an electronic device and a readable storage medium.

FIG. 5 illustrates a block diagram of an electronic device for implementing the method according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 5, the electronic device comprises: one or more processors 501, a memory 502, and interfaces configured to connect components and including a high-speed interface and a low speed interface. Each of the components are interconnected using various buses, and may be mounted on a common motherboard or in other manners as appropriate. The processor can process instructions for execution within the electronic device, including instructions stored in the memory or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 501 is taken as an example in FIG. 5.

The memory 502 is a non-transitory computer-readable storage medium provided by the present disclosure. The memory stores instructions executable by at least one processor, so that the at least one processor executes the method according to the present disclosure. The non-transitory computer-readable storage medium of the present disclosure stores computer instructions, which are used to cause a computer to execute the method according to the present disclosure.

The memory 502 is a non-transitory computer-readable storage medium and can be used to store non-transitory software programs, non-transitory computer executable programs and modules, such as program instructions/modules corresponding to the method in embodiments of the present disclosure. The processor 501 executes various functional applications and data processing of the server, i.e., implements the method in the above method embodiments, by running the non-transitory software programs, instructions and modules stored in the memory 502.

The memory 502 may include a storage program region and a storage data region, wherein the storage program region may store an operating system and an application program needed by at least one function; the storage data region may store data created according to the use of the electronic device. In addition, the memory 502 may include a high-speed random access memory, and may also include a non-transitory memory, such as at least one magnetic disk storage device, a flash memory device, or other non-transitory solid-state storage device. In some embodiments, the memory 502 may optionally include a memory remotely arranged relative to the processor 501, and these remote memories may be connected to the electronic device through a network. Examples of the above network include, but are not limited to, the Internet, an intranet, a blockchain network, a local area network, a mobile communication network, and combinations thereof.

The electronic device may further include an input device 503 and an output device 504. The processor 501, the memory 502, the input device 503 and the output device 504 may be connected through a bus or in other manners. In FIG. 5, the connection through the bus is taken as an example.

The input device 503 may receive inputted numeric or character information and generate key signal inputs related to user settings and function control of the electronic device, and may be an input device such as a touch screen, keypad, mouse, trackpad, touchpad, pointing stick, one or more mouse buttons, trackball and joystick. The output device 504 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network, a wide area network, a block chain network, and the Internet.

The computing system may include clients and servers. A client and server are generally remote from each other and typically interact through a communication network. The relationship of client and server arises by virtue of computer programs running on the respective computers and having a client-server relationship to each other. The server may be a cloud server, also referred to as a cloud computing server or a cloud host, and is a host product in a cloud computing service system to address defects such as great difficulty in management and weak service extensibility in a traditional physical host and VPS (Virtual Private Server) service.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for extracting form information, comprising:
for a form to be processed, obtaining feature information of characters in the form, respectively;
determining types of the characters respectively and determining a reading order of the characters according to the feature information; and
extracting a predetermined type of information content from the form according to the types and the reading order of the characters.

2. The method according to claim 1, wherein the form comprises: a paper-based form;
the method further comprises: obtaining an image corresponding to the form, and perform text detection on the image to obtain detected characters.

3. The method according to claim 2, wherein the feature information comprises: text semantic information of the character, and/or position information of the character, and/or image information of an image region where the character is located.

4. The method according to claim 3, wherein
as for each character, obtaining text semantic information of the character comprises: encoding the semantic information and context information of the character, respectively, and regarding a vector representation obtained from the encoding as the text semantic information of the character;
and/or, as for each character, obtaining position information of the character comprises: obtaining coordinates of an upper left corner and a lower right corner of a rectangular box where the character is located, respectively, and converting the obtained coordinates into a vector representation as the position information of the character, the rectangular frame being a rectangular box of a predetermined size including the character;
and/or, as for each character, obtaining image information of an image region where the character is located comprises: extracting a predetermined image feature from the image region where the character is located, as the image information of the image region where the character is located, the image region where the character is located being an image region corresponding to the rectangular box.

5. The method according to claim 1, wherein the determining a reading order of the characters comprises: determining the next character of each character respectively.

6. The method according to claim 5, wherein
the types of the characters comprise: a primary type which includes a start of a key, a middle of the key, an end of the key, a start of a value, a middle of the value, and an end of the value;
the step of extracting a predetermined type of information content from the form according to the types and the reading order of the characters comprises: extracting explicit key-value pair content from the form in conjunction with the type of each character, and the type of next character of the each character.

7. The method according to claim 5, wherein
the types of the characters comprise: a primary type and a secondary type; the primary type comprises: a start of a cell, a middle of a cell and an end of a cell; the secondary type comprises: whether it is a header;
the step of extracting a predetermined type of information content from the form according to the types and the reading order of the characters comprises: extracting a cell content from the form according to the type of each character and the type of the next character of the each character; for any cell content, if determining any character in the cell content as a header, determining the cell content as header content, and taking the header content and the cell content other than the header content as the table content extracted from the form.

8. The method according to claim 7, further comprising:
determining respectively positions of the extracted header content and cell content in the table, and outputting the header content and cell content sequentially according to the positions.

9. The method according to claim 6, further comprising:
obtaining a question set by the user;
determining an answer corresponding to the question according to text information in the form; and
taking the question and the corresponding answer as implicit key-value pair content extracted from the form.

10. The method according to claim 1, further comprising:
extracting information content of a type other than the predetermined type from the form in a named entity recognition manner.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a method for extracting form information, wherein the method comprises:
for a form to be processed, obtaining feature information of characters in the form, respectively;
determining types of the characters respectively and determining a reading order of the characters according to the feature information; and
extracting a predetermined type of information content from the form according to the types and the reading order of the characters.

12. The electronic device according to claim 11, wherein
the form comprises: a paper-based form;
the method further comprises: obtaining an image corresponding to the form, and perform text detection on the image to obtain detected characters.

13. The electronic device according to claim 12, wherein the feature information comprises: text semantic information of the character, and/or position information of the character, and/or image information of an image region where the character is located.

14. The electronic device according to claim 13, wherein
as for each character, obtaining text semantic information of the character comprises: encoding the semantic information and context information of the character, respectively, and regarding a vector representation obtained from the encoding as the text semantic information of the character;
and/or, as for each character, obtaining position information of the character comprises: obtaining coordinates of an upper left corner and a lower right corner of a rectangular box where the character is located, respectively, and converting the obtained coordinates into a vector representation as the position information of the character, the rectangular frame being a rectangular box of a predetermined size including the character;
and/or, as for each character, obtaining image information of an image region where the character is located comprises: extracting a predetermined image feature from the image region where the character is located, as the image information of the image region where the character is located, the image region where the character is located being an image region corresponding to the rectangular box.

15. The electronic device according to claim 11, wherein the determining a reading order of the characters comprises: determining the next character of each character respectively to obtain a reading order of the characters.

16. The electronic device according to claim 15, wherein
the types of the characters comprise: a primary type which includes a start of a key, a middle of the key, an end of the key, a start of a value, a middle of the value, and an end of the value;
the step of extracting a predetermined type of information content from the form according to the types and the reading order of the characters comprises: extracting explicit key-value pair content from the form in conjunction with the type of each character, and the type of next character of the each character.

17. The electronic device according to claim 15, wherein
the types of the characters comprise: a primary type and a secondary type; the primary type comprises: a start of a cell, a middle of a cell and an end of a cell; the secondary type comprises: whether it is a header;
the step of extracting a predetermined type of information content from the form according to the types and the reading order of the characters comprises: extracting a cell content from the form according to the type of each character and the type of the next character of the each character, and for any cell content, if determining any character in the cell content as a header, determining the cell content as header content, and taking the header content and the cell content other than the header content as the table content extracted from the form.

18. The electronic device according to claim 17, further comprising:
determining respectively positions of the extracted header content and cell content in the table, and outputting the header content and cell content sequentially according to the positions.

19. The electronic device according to claim 16, further comprising:
obtaining a question set by the user;
determining an answer corresponding to the question according to text information in the form; and
taking the question and the corresponding answer as implicit key-value pair content extracted from the form.

20. A non-transitory computer readable storage medium with computer instructions stored thereon, wherein the computer instructions are used for causing a computer to perform a method for extracting form information, wherein the method comprises:
for a form to be processed, obtaining feature information of characters in the form, respectively;
determining types of the characters respectively and determining a reading order of the characters according to the feature information; and
extracting a predetermined type of information content from the form according to the types and the reading order of the characters.
